(19) United States
(12) Patent Application Publication
(10) Pub. No.: US 2014/0150426 A1
(43) Pub. Date: Jun. 5, 2014

(54) DEVICE AND METHOD FOR USING THE WASTE HEAT OF AN INTERNAL COMBUSTION ENGINE

(71) Applicants: Gregory Rewers, Schwieberdingen (DE); Nadja Eisenmenger, Stuttgart (DE); Achim Brenk, Kaempfelbach (DE); Hans-Christoph Magel, Reutlingen (DE); Andreas Wengert, Auenwald (DE); Dieter Seher, Ilsfeld (DE); Michael Krueger, Vaihingen/Enz (DE)

(72) Inventors: Gregory Rewers, Schwieberdingen (DE); Nadja Eisenmenger, Stuttgart (DE); Achim Brenk, Kaempfelbach (DE); Hans-Christoph Magel, Reutlingen (DE); Andreas Wengert, Auenwald (DE); Dieter Seher, Ilsfeld (DE); Michael Krueger, Vaihingen/Enz (DE)

(73) Assignee: ROBERT BOSCH GMBH, Stuttgart (DE)

(21) Appl. No.: 14/118,604

(22) PCT Filed: Apr. 20, 2012
(86) PCT No.: PCT/EP2012/057256

§ 371 Date: Feb. 19, 2014

(30) Foreign Application Priority Data
May 19, 2011 (DE) 10 2011 076 093.8

(51) Int. Cl. F02M 25/07

(52) U.S. Cl. CPC F02M 25/07
USPC 60/605.1; 60/273

(57) ABSTRACT

The invention relates to a method and a device for using the waste heat of an internal combustion engine (2) comprising a thermodynamic working circuit (4) in which a working medium circulates. A pump (6), at least one heat exchanger (8) at least one expansion machine (10) and at least one capacitor (12) are arranged in the direction of flow of the working medium. The mechanical energy generated by the expansion machine (10) is selectively transferred to a drive train (23) and/or at least one other component (25) which can be driven mechanically.

### BACKGROUND OF THE INVENTION

The invention relates to a device and to a method for using the waste heat of an internal combustion engine.

Systems for using the waste heat of internal combustion engines have been in use hitherto only for stationary engines or large engines.

In such systems, the thermal energy is preferably converted into mechanical energy using an ORC (Organic Rankine Cycle) process: A liquid working medium is compressed to a working pressure and conveyed to at least one heat exchanger. The waste heat from the exhaust gas or the exhaust gas recirculation is transmitted via the heat exchanger or exchangers to the working medium of the ORC process which is vaporized as a result. The vapor is subsequently relaxed in an expansion machine, wherein mechanical energy is acquired and output. Preferably piston machines or turbines are used here as expansion machines.

DE 10 2006 057 247 A1 discloses a supercharging device which serves to use the waste heat of an internal combustion engine. At least one heat exchanger of a thermodynamic circuit with a working medium is mounted on the exhaust gas section of the internal combustion engine. Furthermore, a turbine part and a feed unit are arranged in the circuit. A compressor part which is arranged in the intake section of the internal combustion engine is driven via the turbine part.

Since the supply of waste heat in mobile applications depends on the current driving state (traffic situation, load, gradient, velocity etc.), it is subject to severe changes.

Likewise, the demands for working power and the power requirement of the secondary assemblies are subject to strong fluctuations with the result that the distribution of the power acquired from the evaporation process to the crankshaft or the drive train and secondary assemblies of the vehicle has to be continuously adapted in order to permit optimum use of the energy acquired from the waste heat by the thermodynamic working circuit.

### SUMMARY OF THE INVENTION

The object of the present invention is to make available a device and a method for the improved use of the waste heat of an internal combustion engine.

The object is achieved according to the invention by a device for using the waste heat of an internal combustion engine, which device is designed to drive a drive train, wherein the device comprises a thermodynamic working circuit which uses the waste heat of the internal combustion engine to drive an expansion machine. The mechanical output of the expansion machine, which output is, for example, embodied as a drive shaft, is connected to a mechanical distributor device which is suitable for transmitting the mechanical energy, generated by the expansion machine during operation, either to the drive train and/or to at least one further mechanically drivable component (secondary assembly).

In a method according to the invention, the mechanical energy, generated by the expansion machine from the waste heat of the internal combustion engine, is transmitted either to the drive train of the internal combustion engine and/or to a further mechanically drivable component (secondary assembly).

A device according to the invention and a method according to the invention permit optimum use of the waste heat of the internal combustion engine in any operating state since the mechanical energy transmitted to the drive train or to the further component can be adapted in an optimum way to the respective operating state.

In one embodiment, the at least one further component is embodied as an electric generator. In this way, the waste heat of the internal combustion engine can be used to generate the electric current which is necessary to operate, for example, a vehicle. As a result of the use of the waste heat, the internal combustion engine is not additionally loaded, with the result that increased fuel consumption is avoided.

In one embodiment, the at least one further component is embodied as a hydraulic compressor or as a pneumatic compressor. In this way, the hydraulic or pneumatic pressure, such as is necessary for operating a brake system, for example, can be generated by using the waste heat of the internal combustion engine. As a result of the use of the waste heat, the internal combustion engine is not additionally loaded, with the result that increased fuel consumption is avoided.

In one embodiment of the invention, the portion, respectively transmitted to the drive train and the further component, of the mechanical energy generated by the expansion machine can be varied. A variable transmission of energy permits particularly efficient use of the energy generated by the expansion machine since the distribution of the energy can always be adapted in an optimum way to the respective operating state and to the energy which is respectively required at a particular time by the component.

The distributor device is embodied, for example, as a distributor gear mechanism and, in particular, as a planetary gear mechanism. In this context, the sun gear of the planetary gear mechanism is connected, for example, to the internal combustion engine, the planetary carrier is connected to the expansion machine, and the ring gear is connected to the further component.

With such a design of the distributor device as a planetary gear mechanism, a change in the load of the further component causes the mechanical torque acting on the ring gear of the planetary gear mechanism also to change. As a result, both the load distribution of the energy, output by the expansion machine, between the further component and the drive train and the transmission ratio between the internal combustion engine and the expansion machine can be varied in an infinitely adjustable fashion. Such a planetary gear mechanism therefore makes available a cost-effective, loadable and reliable distributor device which permits infinitely variable distribution of the energy, generated by the expansion machine, to the drive train and to at least one further component.

If the further component is an electric generator which is configured for two-quadrant operation, the generator can also be operated as an engine, and there is the possibility of using the generator via the distributor device as a starting device for the expansion machine. This is advantageous in particular when the expansion machine is an expansion machine which does not start independently but has to be started by a starter.

Between the distributor gear mechanism and the internal combustion engine it is possible to provide a freewheel in order to prevent the internal combustion engine being entrained by a faster running expansion machine at a low rotational speed (for example during idling) and in the process consuming energy generated by the expansion machine.

If a further component is embodied as a hydraulic or pneumatic compressor, a pressure accumulator can additionally be provided in order to store excess energy, not required for driving the drive train in a respective operating state at that particular time, for later use.

In one advantageous embodiment, a step-up or step-down gear mechanism is arranged between the expansion machine and the distributor gear mechanism, said step-up or step-down gear mechanism being designed to convert the rotational speed of the expansion machine to the rotational speed of the internal combustion engine or of the drive train. A planetary gear mechanism can also be used as a step-up or step-down gear mechanism.

In addition to the embodiment of the further component as a generator, hydraulic compressor and/or pneumatic compressor, further variants are conceivable in which the mechanical energy output by the distributor gear mechanism is used to drive further secondary assemblies. If the load of the secondary assemblies can be regulated, a variable load distribution can also be implemented without a variable distributor gear mechanism.

### BRIEF DESCRIPTION OF THE INVENTION

The invention will be explained in more detail below with reference to the appended figures, of which:

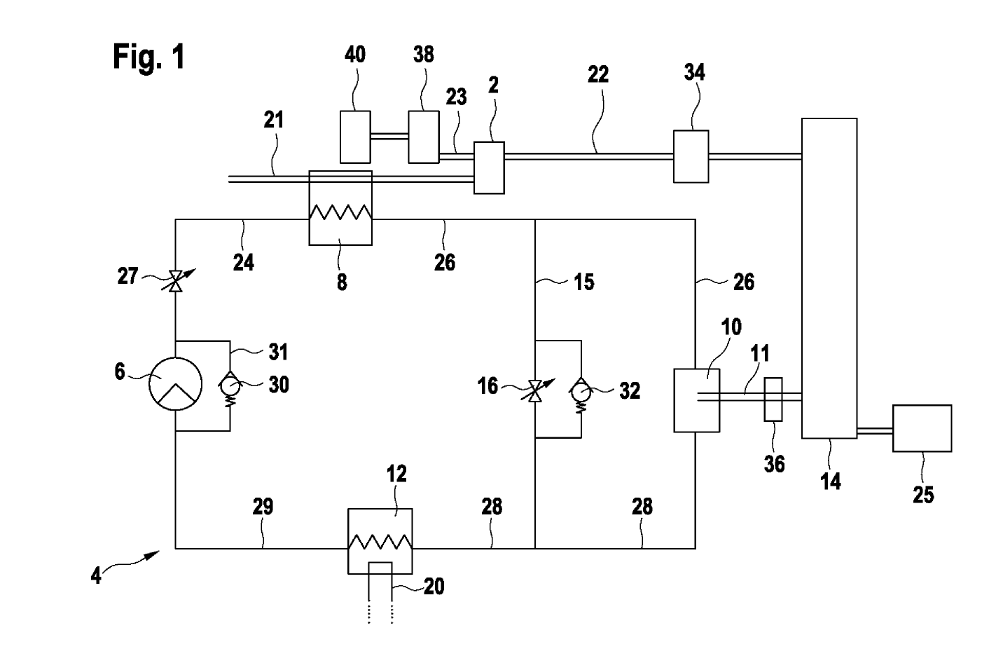

FIG. 1 shows a schematic illustration of a device for using the waste heat of an internal combustion engine with a thermodynamic working circuit, and

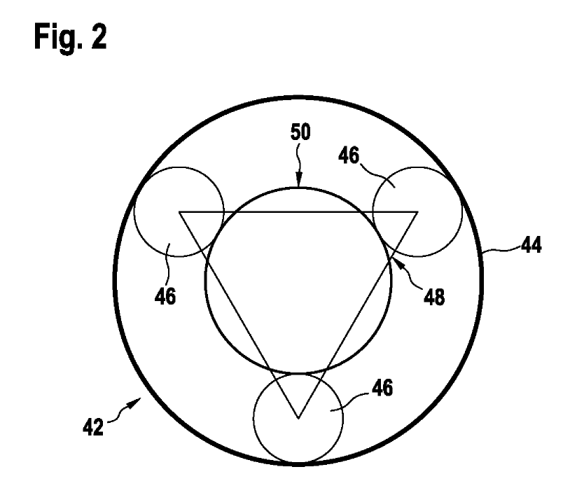

FIG. 2 shows a schematic section through a planetary gear mechanism such as can be used as a distributor gear mechanism.

### DETAILED DESCRIPTION

In this context, FIG. 1 shows a schematic illustration of a device for using the waste heat of an internal combustion engine 2 with a thermodynamic working circuit 4 in which a working medium circulates. Arranged in the direction of flow of the working medium in the thermodynamic working circuit 4 are a heat exchanger 8, an expansion machine 10, a condenser 12 and a pump 6.

The internal combustion engine 2 can be configured, in particular, as an air-compressing, auto-ignition or mixture-compressing, spark-ignition internal combustion engine 2. The device is especially suitable for using waste heat for applications in motor vehicles with a spark-ignition engine or diesel engine. A device according to the invention for using waste heat is, however, also suitable for other applications.

The internal combustion engine 2 burns fuel in order to generate mechanical energy. The waste gases produced in the process are expelled via an exhaust system 21 in which an exhaust gas catalytic converter (not shown in FIG. 1) can be arranged. A line section of the exhaust system 21 is led through a heat exchanger 8. Thermal energy from the exhaust gases or the exhaust gas recirculation is transmitted via the line section 21 in the heat exchanger 8 to the working medium of the thermodynamic working circuit 4, with the result that the working medium is heated in the heat exchanger 8 and, if appropriate, overheated and vaporized.

The heat exchanger 8 of the thermodynamic working circuit 4 is connected via a line 26 to the expansion machine 10. The expansion machine 10 can be configured, for example, as a turbine or piston machine. The heated working medium flows through the line 26 to the expansion machine 10 and drives the latter.

The expansion machine 10 has a drive shaft 11 via which the mechanical energy generated by the expansion machine 10 is output. After flowing through the expansion machine 10, the working medium is conducted through a line 28 to a condenser 12. The working medium which is relaxed via the expansion machine 10 is cooled in the condenser 12 and, if appropriate, liquefied. The condenser 12 can be connected to a cooling circuit 20 in order to particularly effectively conduct the heat out of the working medium. This cooling circuit 20 may be, for example, the cooling circuit of the internal combustion engine 2. The working medium which is cooled in the condenser 12 is fed through the line 29 into the line 24 by a pump 6.

In the line 24 there is a pressure-regulating valve 27 which serves to regulate the pressure of the working medium in the inflow to the heat exchanger 8. The evaporation temperature of the working medium can be regulated using the pressure, set by the pressure-regulating valve 27, in the inflow to the heat exchanger 8.

In addition, a bypass connection 31 can be provided parallel to the pump 6, in which bypass connection 31 an overpressure valve 30 is located. The maximum permissible pressure of the working medium between the pump 6 and the heat exchanger 8 can be limited by the overpressure valve 30.

The line 24 leads directly into the heat exchanger 8 in which the working medium is heated and, if appropriate, vaporized and/or overheated. The heated working medium passes again to the expansion machine 10 via the line 26, and the working medium flows through the thermodynamic working circuit 4 again.

The direction in which the working medium runs through the thermodynamic working circuit 4 is defined by the pump 6 and the expansion machine 10. As a result, thermal energy can be continuously extracted from the exhaust gases and the components of the exhaust gas recirculation of the internal combustion engine 2 via the heat exchanger 8, said thermal energy being output to the shaft 11 in the form of mechanical energy.

Water or some other fluid which corresponds to the thermodynamic requirements can be used as the working medium. The working medium experiences thermodynamic changes of state as it flows through the thermodynamic working circuit 4. In the liquid phase, the working medium is placed at the pressure level for evaporation by the pump 6. The thermal energy of the exhaust gas is then output to the working medium via the heat exchanger 8. In the process, the working medium is vaporized in isobaric fashion and subsequently overheated.

The vapor is relaxed adiabatically in the expansion machine 10. In the process, mechanical energy is acquired and transmitted to the shaft 11. The working medium is subsequently cooled in the condenser 12 and fed to the pump 6 again.

In the thermodynamic working circuit 4 there is a bypass connection 15 which is connected parallel to the expansion machine 10. The bypass connection 15 forms a connection between the line 26 between the heat exchanger 8 and the expansion machine 10, and the line 28 between the expansion machine 10 and the condenser 12. A further bypass pressure-regulating valve 16 is arranged in the bypass connection 15. Instead of the further bypass pressure-regulating valve 16 it is also possible for a pressure-limiting valve 32 to be located in the bypass connection 15. By opening the bypass pressure-regulating valve 16 it is possible for the working medium to be conducted past the expansion machine 10 and directly from the heat exchanger 8 to the condenser 12 in order to prevent damage to components of the line 26 and/or of the expansion machine 10 when there is a high pressure in the working circuit 4.

The drive shaft 11 of the expansion machine 10, a region 22 of the drive shaft of the internal combustion engine 2 and at least one further component 25 are connected to a distributor gear mechanism 14. The distributor gear mechanism 14 is embodied in such a way that the mechanical energy, output by the expansion machine 10 via its drive shaft 11, can be transmitted, in addition to the mechanical energy supplied by the internal combustion engine 2, either to the drive shaft 22, 23 or to the additional component 25. The drive shaft 22, 23 can be, for example, part of the drive train of a vehicle which drives the driven wheels of the vehicle via a suitable gear mechanism 40, a clutch 38 and a differential (not shown in the figure).

The further component 25 may be, for example, an electric generator, a hydraulic compressor or a pneumatic compressor.

In the course of the drive shaft 22, a freewheel 34 is arranged between the internal combustion engine 2 and the distributor gear mechanism 14 in order to prevent the expansion machine 10 being “entrained” by the internal combustion engine 2 via the distributor gear mechanism 14 when the supply of waste heat of the internal combustion engine 2 is low, and in the process taking up energy from the internal combustion engine 2.

In the course of the drive shaft 11 of the expansion machine 10, a step-up or step-down gear mechanism 36 is provided which is designed to adapt the rotational speed of the drive shaft 11 of the expansion machine 10 to the rotational speed of the drive shaft 22 of the internal combustion engine 2 or of the drive train 23.

FIG. 2 shows a schematic section through a planetary gear mechanism 42 such as can be used as a distributor gear mechanism 14. In an exemplary embodiment, the drive shaft 22 of the internal combustion engine 2 is connected to the sun gear 50 of the planetary gear mechanism 42. The expansion machine 10 acts on the planetary carrier 48 of the planetary gear mechanism 42, and the further component 25 is operatively connected to the ring gear 44 of the planetary gear mechanism 42.

With such a design, a change in the load of the component 25 causes the mechanical torque acting on the ring gear 44 of the planetary gear mechanism 40 to change. With such a design it is possible, by changing the load of the component 25, to vary infinitely both the load distribution of the energy, output by the expansion machine 10, between the component 25 and the drive train 23, and the transmission ratio between the internal combustion engine 2 and the expansion machine 10.

1. A device for using the waste heat of an internal combustion engine (2), which device is designed to drive a drive train (23), wherein the device comprises a thermodynamic working circuit (4) having an expansion machine (10), and a distributor device (14) which is mechanically connected to the expansion machine (10) to transmit mechanical energy output by the expansion machine (10) during operation either to the drive train (23) or to at least one further mechanically drivable component (25).

2. The device as claimed in claim 1, wherein the further component (25) is an electric generator, a hydraulic compressor or a pneumatic compressor.

3. The device as claimed in claim 1, wherein the distributor device (14) is designed in such a way that a portion of the energy transmitting to the drive train (23) and the further component (25) is variable.

4. The device as claimed in claim 1, wherein the distributor device (14) is embodied as a planetary gear mechanism (42).

5. The device as claimed in claim 4, wherein a crankshaft of the internal combustion engine (2) is connected to a sun gear (50) of the planetary gear mechanism (42), the expansion machine (10) acts on a planetary carrier (48) of the planetary gear mechanism (42), and the further component (25) is operatively connected to a ring gear (44) of the planetary gear mechanism (42).

6. The device as claimed in claim 1, wherein the distributor device is a two-quadrant gear mechanism.

7. The device as claimed in claim 1, wherein a freewheel (34) is arranged between the internal combustion engine (2) and the distributor device (14).

8. The device as claimed in claim 1, wherein a step-up or step-down gear mechanism (36) is arranged between the expansion machine (10) and the distributor device (14).

9. The device as claimed in claim 1, wherein the distributor device (14) is configured as a starting device for starting the expansion machine (10).

10. A method for using the waste heat of an internal combustion engine (2) which is designed to drive a drive train (23), with a thermodynamic working circuit (4) which drives an expansion machine (10), comprising transmitting mechanical energy, generated by the expansion machine (10), to at least one of the drive train (23) and at least one further mechanically drivable component (25).

11. The method as claimed in claim 10, further comprising varying a portion of the energy transmitted to the drive train or to the further component.
